(19) United States
(12) Patent Application Publication
(10) Pub. No.: US 2021/0065269 A1
(43) Pub. Date: Mar. 4, 2021

(54) LISTING SUPPORT METHOD AND SYSTEM

(71) Applicant: MERCARI, INC., Tokyo (JP)

(72) Inventors: Daiki KUMAZAWA, Tokyo (JP); Hiroyuki SOHARA, Tokyo (JP); Lain MATSUOKA, Tokyo (JP); Hirofumi NAKAGAWA, Tokyo (JP)

(21) Appl. No.: 16/995,453

(22) Filed: Aug. 17, 2020

(30) Foreign Application Priority Data
Aug. 27, 2019 (JP) 2019-154737

(51) Int. Cl. G06Q 30/06; G06K 9/00; G06K 9/32

(52) U.S. Cl. CPC G06Q 30/0617; G06K 9/3241; G06K 9/00671; G06Q 30/0643

(57) ABSTRACT

There is provided a listing support system or the like smoothly performing the guidance after the start of the listing procedure, particularly providing flexible listing support according to a wide variety of categories of listed items, and a method for providing an article commerce intermediation service on a server configured to be accessible from multiple user terminals, the method comprising: continuously recognizing an article in an image shot by a user terminal; extracting a category of the article by the recognition; and starting a listing procedure for treating the article as a listing item in commerce intermediation based on the extracted category.

### CROSS REFERENCE TO RELATED APPLICATION

This application claims priority to Japanese Patent Application No. 2019-154737, filed on Aug. 27, 2019 with the Japanese Intellectual Property Office, the disclosure of which is incorporated herein by reference.

### BACKGROUND OF THE INVENTION

### Field of the Invention

The present invention relates to a listing support system that operates widely on networks such as the Internet, particularly to a listing support system or the like that uses images and the like related to a listing item.

### Description of the Related Art

Electronic commerce systems for trading items and the like online, for example, on the Internet have been widely used. Examples include auction systems and online flea markets. Some of these systems use images related to listing items.

For example, a listing support device has been provided that simplifies the creation of listing pages posted on a website (Japanese Patent Laid-Open No. 2014-115912).

Japanese Patent Laid-Open No. 2014-115912 discloses a listing support device including receiver means that receives an item image of an item listed by a user from a user terminal; search means that searches for similar images similar to the item image received by the receiver means, from an image storage device that stores images of items purchased by the user in the past; and generator means that generates a listing page including the item image received by the receiver means and item information related to items in the similar images found by the search means.

In addition, an item listing support system and the like have been proposed that can give a shooting guide, allowing users to interactively (conversationally) list items (Japanese Patent Laid-Open No. 2019-012474).

Japanese Patent Laid-Open No. 2019-012474 discloses an item listing support system including a receiver unit that receives selection of category information indicating the category of an item to be listed; an output unit that outputs shooting guide information for assisting a user in shooting depending on the category information; a shooting unit that receives an instruction to shoot the item to be listed, associating it with the output shooting guide information; and a storage unit that stores the shooting guide information and image information indicating the item to be listed shot by the shooting unit, and the output unit outputs, according to at least one of the previous shooting guide information and the image information stored in the storage unit, new shooting guide information for assisting the next shooting.

However, conventional listing support systems and the like provide listing support that uses images and the like related to listing items, but it cannot always be said that they are flexible in guiding the process from turn-on of the camera of the user terminal used by a seller (user) to the start of the listing procedure, for example. In particular, they do not provide smooth determination of categories of listing items that are rich in variety or flexible listing support depending on the category; from this point of view, highly convenient systems and the like are required.

### SUMMARY OF THE INVENTION

In view of this, a listing support program or the like according to an embodiment of the present invention is a program executed on multiple user terminals in a system providing an article commerce intermediation service run by a server configured to be accessible from the user terminals, the program causing, when executed on the user terminal, the user terminals to execute: a step of continuously recognizing an article in an image shot by the user terminal; a step of extracting a category of the article by the recognition; and a step of starting a listing procedure for treating the article as a listing item in commerce intermediation based on the extracted category.

The listing support program and the like according to an embodiment of the present invention produce the effect of smoothly performing the guidance after the start of the listing procedure, particularly providing flexible listing support according to a wide variety of categories of listing items or a listing support system used to support listing.

### BRIEF DESCRIPTION OF THE DRAWINGS

FIG. 1A is an explanatory diagram for explaining the basic concept of a listing support program and the like according to an embodiment of the present invention;

FIG. 1B is an explanatory diagram for explaining the basic concept of a listing support program and the like according to an embodiment of the present invention;

FIG. 2 is an explanatory diagram for explaining an example of the entire configuration of a listing support system according to an embodiment of the present invention;

FIG. 3 is an explanatory diagram for explaining the external configuration of an information processing device in a listing support system according to an embodiment of the present invention;

FIGS. 4A and 4B are explanatory diagrams for explaining a functional block of an information processing device in a listing support system according to an embodiment of the present invention (FIG. 4A), and a functional block of a server in a listing proxy support system according to an embodiment of the present invention (FIG. 4B);

FIG. 5 is an explanatory diagram for explaining example operation of a listing support system or the like according to an embodiment of the present invention;

FIG. 6 is an explanatory diagram for explaining the concept of operation of a listing support system or the like according to an embodiment of the present invention;

FIG. 7 is an explanatory diagram for explaining the configuration of a queue (result storage queue) in a listing support system or the like according to an embodiment of the present invention;

FIG. 8 is an explanatory diagram for explaining an example screen of an information processing device (user terminal) in a listing support system or the like according to an embodiment of the present invention;

FIG. 9 is an explanatory diagram for explaining an example screen of an information processing device (user terminal) in a listing support system or the like according to an embodiment of the present invention;

FIG. 10A is an explanatory diagram for explaining example screen transition in an information processing device (user terminal) in a listing support system or the like according to an embodiment of the present invention;

FIG. 10B is an explanatory diagram for explaining example screen transition in an information processing device (user terminal) in a listing support system or the like according to an embodiment of the present invention;

FIG. 11 is an explanatory diagram for explaining an example screen of an information processing device (user terminal) in a listing support system or the like according to an embodiment of the present invention;

FIG. 12 is an explanatory diagram for explaining an example screen of an information processing device (user terminal) in a listing support system or the like according to an embodiment of the present invention;

FIG. 13A is an explanatory diagram for explaining example screen transition in an information processing device (user terminal) in a listing support system or the like according to another embodiment of the present invention;

FIG. 13B is an explanatory diagram for explaining example screen transition in an information processing device (user terminal) in a listing support system or the like according to another embodiment of the present invention;

FIG. 13C is an explanatory diagram for explaining example screen transition in an information processing device (user terminal) in a listing support system or the like according to another embodiment of the present invention;

FIG. 14 is an explanatory diagram for explaining example screen transition in an information processing device (user terminal) in a listing support system or the like according to an embodiment of the present invention; and

FIG. 15 is an explanatory diagram for explaining example screen transition in an information processing device (user terminal) in a listing support system or the like according to an embodiment of the present invention.

### DETAILED DESCRIPTION OF THE PREFERRED EMBODIMENTS

First, the terms used in this embodiment will be defined.

### [Listing]

A seller's act of listing a seller's item in item trading, auctions, and the like. Listing an item on an online system is online listing. When an item is listed on the online system, listing information is registered in the system.

### [Guiding]

Processing in a computer to guide a user to a desired state (goal). It is typically accomplished through UI/UX.

### [Guide Trigger]

A trigger to start guide or listing guide or an act of satisfying conditions for starting guide and actually starting or triggering guide.

### [Item Suggestion]

It is intended to broadly include conventional guiding methods that are not limited to guiding unique to the present invention.

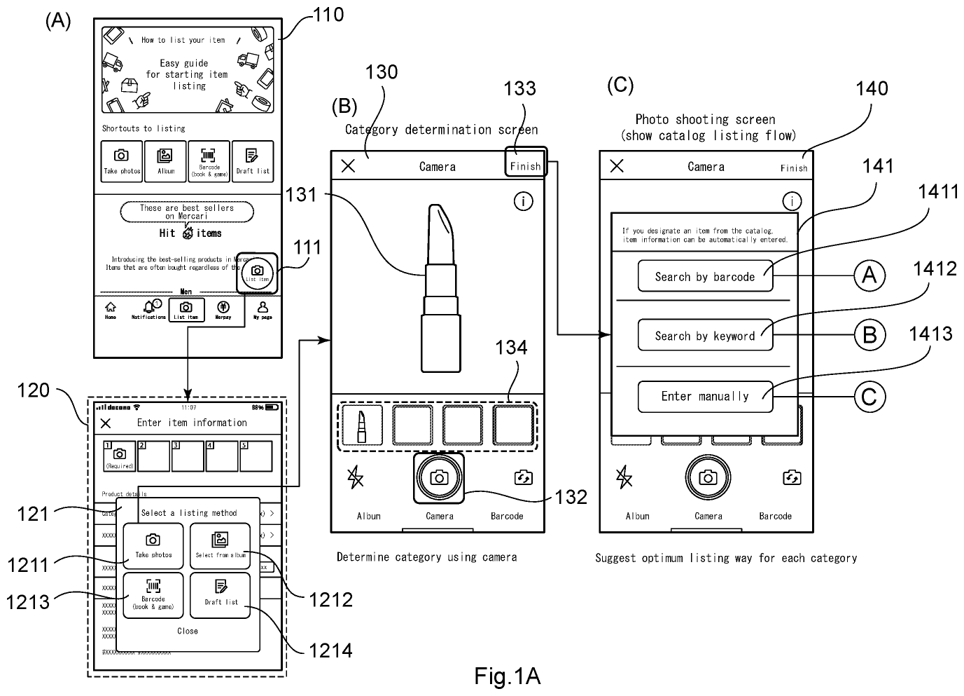

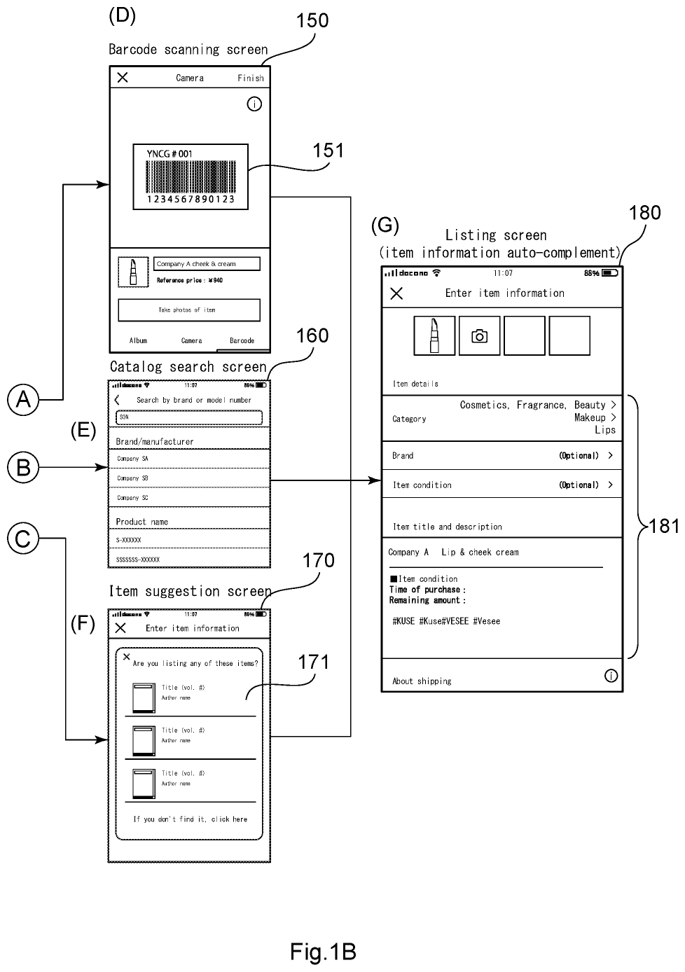

FIGS. 1A and 1B are explanatory diagrams for explaining the basic concept of a listing support program and the like according to an embodiment of the present invention. For easy understanding, the basic concept of a listing support program and the like according to an embodiment of the present invention is shown based on an example of screen operation and screen transition during use of a service viewed from a user terminal.

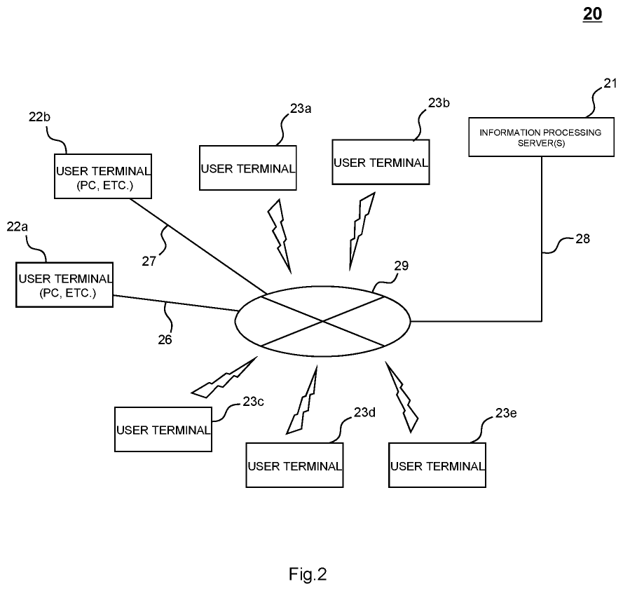

FIGS. 1A and 1B illustrate how the screen of the user terminal makes a transition in response to an operation. The user terminal in FIGS. 1A and 1B is connected to an article commerce intermediation service system (which may be a part of an information processing server (group) 21 described later with reference to FIG. 2), which is not shown in the drawing, and the screen 110 shown in FIG. 1A (A) is an example of a screen displayed when an item is to be listed.

In an embodiment of the present invention, pressing a listing button 111 on a screen 110 (which is not always pressing a physical button and may be touching, tapping, or clicking a button displayed on the screen (the same applies to the term “press” hereinafter)), causes a transition of the user terminal screen to a screen 120 for input of information on an item to be listed. In an embodiment, the screen 120 shows a selection screen 121 for listing method selection on the top layer. This selection menu screen shows a button 1211 (with the caption “Take photos”) for taking photos (including not only still images but moving images (the same applies to the following description)) and entering listing information, a button 1212 (with the caption “Select from album”) for acquiring listing information from an album or catalog and entering it, and a button 1213 (with the caption “Barcode (book/game)” for reading the barcode on the item or item packaging to acquire and enter listing information. A button 1214 is a button for browsing, for example, pages being prepared for listing and saved as drafts (pressing this button causes a transition to a draft list screen (not shown in the drawing)).

Pressing the button 1211 on the screen 121 causes a transition to a category determination screen 130 (FIG. 1A (B)). On the screen 130, a camera application is active, and what is captured by the camera of the user terminal (not shown in the drawing) is displayed in the area 131. In an embodiment of the present invention, as will be described later, the category of the displayed article can be determined and the category name or the article name can be displayed on the screen 130.

In an embodiment, when the user presses the camera button (icon) 132, the leftmost image in a photo frame (in which the lipstick is shown) in the area 134 on the screen is stored as a photo, and a transition to the photo shooting screen 140 (FIG. 1A (C)) automatically occurs. It should be noted that at this time, the determined category name or article name should not necessarily be displayed on the screen 130, but even if the category name or article name is not shown, the act of user taking a picture of the article that the user was going to list (for example, pressing the camera button 132) can trigger a transition to the photo shooting screen 140.

Alternatively, in another embodiment, if the category or the article name displayed on the screen 130 is correct to the user, the button 133 is pressed (the caption “Finish” assigned here is not necessarily used and may be replaced with “confirm”, “shoot”, or the like). Pressing the button 133 causes a transition to the photo shooting screen 140 (FIG. 1A (C)). At this time, the determined category name or article name should not necessarily be displayed on the screen 130.

On the screen 140, an optimal listing method for each category is proposed (that is, the listing method presented is different depending on the determined category of the listing item), and the selection screen 141 is displayed on the top layer in an embodiment. The screen 141 shows a button 1411 (with the caption “Search by barcode”) for reading a barcode and entering item information, a button 1412 (with the caption “Search by keyword”), and a button 1413 (with the caption “Enter manually”).

Pressing the button 1411 causes a transition to a barcode scanning screen 150, pressing the button 1412 causes a transition to a catalog search screen 160, and pressing the button 1413 causes a transition to an item suggestion screen 170.

FIG. 1B shows a screen after a transition from FIG. 1A, FIG. 1B (D) shows a barcode scanning screen 150, FIG. 1B (E) shows a catalog search screen 160, and FIG. 1B (F) shows an item suggestion screen 170. As will be described individually later as needed, on the barcode scanning screen 150, the barcode 151 attached to the item or the item packaging is read to acquire and input item information. On the catalog search screen 160, item information is acquired and entered by selecting or entering catalog information (for example, manufacturer name and product model number) on the item (in an embodiment, catalog information is stored in an information processing server (group) 21 which will be described with reference to FIG. 2). On the item suggestion screen 170, the item is specified during execution of an estimation process for narrowing down the list of items as displayed on the screen 171, and the specified item information is acquired and entered.

In an embodiment, the information acquired and entered through the screens 150, 160, and 170 is reflected on the next listing screen 180 (FIG. 1B (G)). As illustrated in the drawing, the acquired and entered item information is shown in the item information field 181.

### (Basic Concept of Listing Support Program and the Like According to an Embodiment of the Present Invention)

The basic concept of the listing support program and the like according to an embodiment of the present invention that has been described so far is as follows.

(1) The listing support program and the like according to an embodiment of the present invention is started by pressing a listing button (a button for starting the listing procedure).

(2) At least object recognition processing technology or category determination technology is used to determine the category of the listing item.

(3) After the category of the listing item is determined, a process for supplementing or complementing the item information is performed by various methods. At this time, the process for supplementing or complementing the item information can be changed depending on the determined listing item category.

FIG. 2 shows an example of the entire configuration of a listing support system according to an embodiment of the present invention. As shown in FIG. 2, the listing support system 20 consists of an information processing server (group) 21, and a device for processing various information used by the user (the drawing illustrates user terminals 22a to 22b such as PCs, user terminals 23a to 23e as smartphones, mobile phones, personal digital assistants or tablet terminals which will be collectively referred to as “terminals”) as components, and the server (group) and various terminals are connected so that they can communicate with each other via a private line or a public line such as the Internet (wired lines are denoted by the reference numerals 26 to 28) as shown in FIG. 2. Each line may be wiring or established wirelessly, and the user terminals 23a to 23e make wireless access to the Internet 29 via a base station, a wireless router, or the like, which is not shown in the drawing, and are also connected so that they can communicate with the information processing server (group) 21 via a line 28.

In an embodiment of the present invention, the information processing server (group) 21 may include a messaging server through which the terminals shown in FIG. 1 exchange messages and the like. Alternatively, the terminals shown in FIG. 1 may exchange messages and the like via another communication server not shown in FIG. 2.

In addition, many user terminals at the time of filing this application have processing capabilities (for example, communication processing speed and image processing capacity) equivalent to those of PCs, and should be called compact computers.

In addition, programs or software necessary for implementing the present invention are usually installed or stored in the HDD or SSD in the storage unit of the terminal. When a program or software is executed, all or part of its software module is read in the memory in the storage unit as necessary and is subjected to operations in the CPU.

It should be noted that operations should not necessarily be executed in a central processing unit such as a CPU, and an auxiliary arithmetic device such as a graphics processing unit (GPU), a tensor processing unit (TPU), or a digital signal processor (DSP) not shown in the drawing may be used instead.

In addition, basically, a PC can be used for the hardware configuration of the information processing server 11. Although the present invention is not limited to this, the information processing server 11 may have a configuration suitable for processing a large amount of data by operating a plurality of PCs in parallel to increase its hardware performance as necessary.

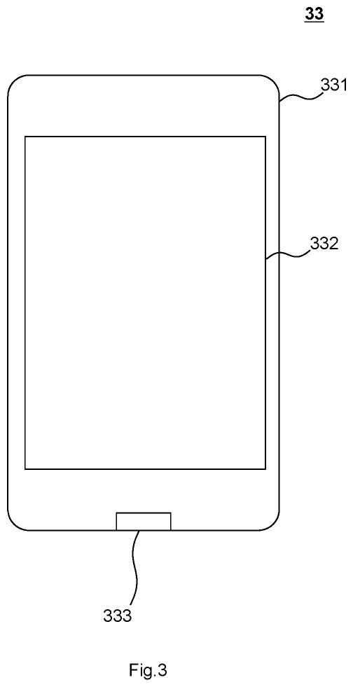

FIG. 3 shows the appearance of a smartphone (which may be another user terminal such as a tablet terminal, but is supposed to be a smartphone for convenience of description) as an information processing device according to an embodiment of the present invention. In FIG. 3, the information processing device (smartphone) 33 includes a housing 331, a display 332, and a hardware button 333 provided in a lower central portion of the housing 331. The display 332 typically consists of a liquid crystal display (LCD) or the like, and can display various information such as characters and images. Menu buttons or a software keyboard is also displayed on the display 332 and touching this with a finger or a touch pen (not shown in the drawing) can give an instruction (command) to the smartphone 33. In this respect, the hardware button 333 is not an essential component but is mounted as a button having a certain function, for convenience of description of the present invention. Naturally, these hardware buttons 333 can be replaced by menu buttons displayed on a part of the display 332.

The display 332 includes a multi-touch input panel, and touch input position coordinates on the touch input panel are transmitted to a processing system (CPU) of the smartphone 33 via an input device interface (not shown in the drawing) and processed. The multi-touch input panel is configured to sense a plurality of touch points on the panel at the same time. This detection (sensor) can be implemented by various methods and is not necessarily a contact sensor, and can extract a designated point on the panel using an optical sensor, for example. In addition, the sensor can be not only a contact sensor or an optical sensor but a capacitance sensor that senses a contact with human skin.

Although not shown in FIG. 3, the smartphone 33 can also be include a microphone or speaker. In this case, the user's voice or the like picked up from the microphone can be determined and used as an input command. Further, although not shown in FIG. 3, a camera device such as a CMOS is mounted on, for example, the back surface of the smartphone 33.

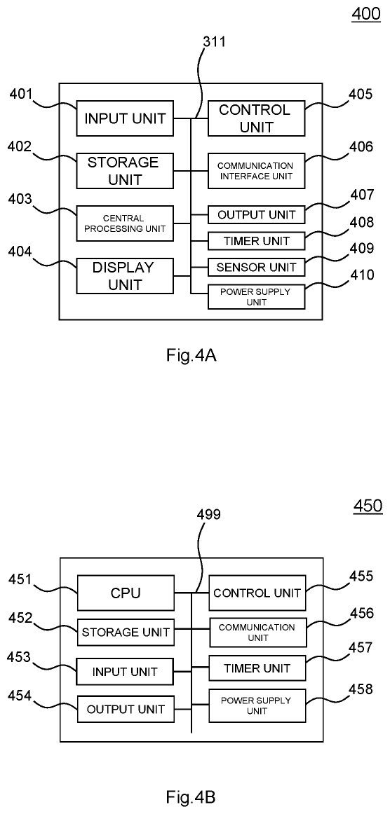

FIG. 4 illustrates a functional block diagram of a hardware constituting the smartphone 23 according to an embodiment of the present invention (FIG. 4A) and a functional block diagram of a hardware constituting the server (one in the information processing server group) 21 according to an embodiment of the present invention (FIG. 4B). The operations of the smartphone 23 and the server 21 are implemented by the individual operations of the hardware described below and their linked operations.

In FIG. 4A, the smartphone 400 as the entire hardware block is roughly classified into the hardware button 333 shown in FIG. 3, a multi-touch input panel provided on the display 332, an input unit 401 consisting of a microphone or the like, hard disk for storing programs and data, a storage unit 402 consisting of a RAM and/or a ROM, a central processing unit 403 consisting of a CPU that performs various numerical calculations and logical operations according to programs, a display unit 404 consisting of the display 332 or the like, a control unit 405 for controlling chips, electric systems, and the like, a communication interface unit 406 consisting of a slot for a access to the Internet, a port for optical communication, and a communication interface, an output unit 407 such as a speaker or a vibrator, a timer unit 408 for measuring time or the like, a sensor unit 409 consisting of an image sensor such as CMOS, and a power supply unit 410 for supplying power to each module in the device. These modules are connected to each other via a communication bus or a power supply line (in FIG. 4A, the lines are collectively shown as a connection 411 in which the lines are appropriately separated) as needed.

Note that the sensor unit 409 may include a GPS sensor module for specifying the position of the smartphone 400 (23a or the like). A signal detected by an image sensor such as a CMOS that constitutes the sensor unit 409 is processed as input information by the input unit 401.

In addition, programs or software necessary for implementing the present invention are usually installed or stored in a hard disk or the like constituting the storage unit 402. When a program or software is executed, all or part of its software module is read in the memory in the storage unit 402 as necessary and is subjected to operations in the central processing unit 403 such as a CPU.

It should be noted that operations should not necessarily be executed in central processing unit 403 such as a CPU, and an auxiliary arithmetic device such as a graphics processing unit (GPU), a tensor processing unit (TPU), or a digital signal processor (DSP) not shown in the drawing may be used instead.

In FIG. 4B, the server 450 as an entire hardware block is roughly classified into a CPU 451 for various comparison/arithmetic processing, a storage unit 452, such as a RAM, a ROM, or a flash memory, an input unit 453, such as a keyboard or a pointing device, an output unit 454, such as a display or a speaker, a control unit 455 for controlling various signals, a (wireless or wired) communication (interface) unit 456, a timer unit 457 for measuring time or the like, and a power supply unit 458.

These modules are connected via a communication bus and a power supply line as needed and appropriate (in FIG. 4B, for convenience, the lines are collectively shown as a connection 499 in which the lines are appropriately separated).

In addition, programs or software which are executed in the server 450 and are necessary for implementing the present invention are usually installed or stored in a hard disk, a solid state drive (SSD), a flash memory, or the like constituting the storage unit 452. When a program or software is executed, all or part of its software module is read in the memory in the storage unit 452 as necessary and is subjected to operations in the CPU 451.

It should be noted that operations should not necessarily be executed in a central processing unit such as the CPU 451, and an auxiliary arithmetic device such as a graphics processing unit (GPU), a tensor processing unit (TPU), or a digital signal processor (DSP) not shown in the drawing may be used instead.

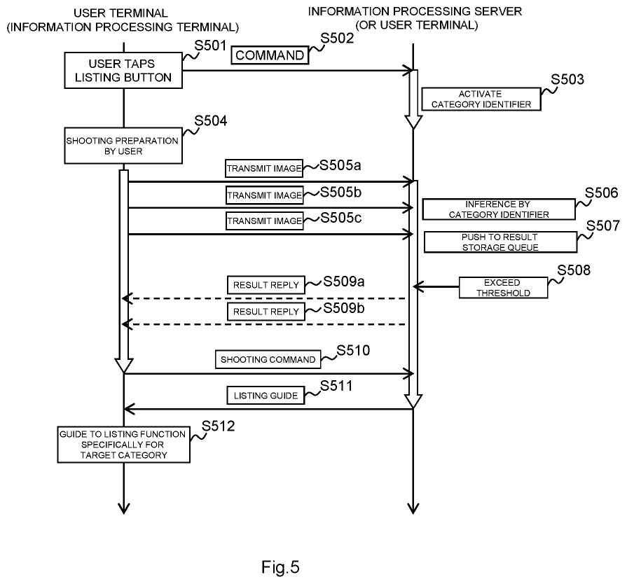

The operation of the information processing server and/or the information processing device (user terminal) in the listing support system according to an embodiment of the present invention will now be described using the operation flow shown in FIG. 5.

In FIG. 5, the “user terminal” is an information processing device and corresponds to each of the user terminals 23a to 23e and the like in FIG. 2, and the “information processing server” is the information processing server (group) 21 in FIG. 1. Although the description has been made of the communication between the user terminal and the information processing server in an embodiment with reference to FIG. 5, the present invention is not limited to this and a part or all of the processing in the information processing server may be performed by the user terminal. In particular, in another embodiment of the present invention, all or a part of the processing shown in FIG. 5 may be performed in the same user terminal.

This will be described below with reference to FIG. 5.

First, in Step S501, when the user taps the listing button displayed on the user terminal (corresponding to pressing the listing button 111 in FIG. 1A), a command is issued or transmitted from the user terminal (Step S502). In an embodiment, this command activates a category identifier in the user terminal (Step S503). In an embodiment, this category identifier is implemented as software. As described above, in another embodiment, the category identifier may be executed in the information processing server. In that case, in Step S502, a command is transmitted from the user terminal to the information processing server.

In Step S504, the user prepares for shooting. At this time, for example, the user holds the user terminal with the activated category identifier and tries to capture an image of the subject to be listed with the camera attached to the user terminal.

In an embodiment of the present invention, Step S504 corresponds to the screen 130 in FIG. 1A (B) shown after a transition caused by pressing the listing button. Here, pressing the listing button activates the camera function and also the category identifier in the background.

Next, the image captured by the camera attached to the terminal is transmitted from the user terminal to the information processing server every instant (Steps S505a to S505c). The image transmitted at this time may be a still image or a moving image.

In Step S506, the object in the image is continuously inferred by the already activated category identifier. Known object recognition technology or category determination technology can be adopted as the inference logic. For example, for category determination, general object recognition technology may be used alone or in combination with specific object recognition technology as necessary. Typical methods of specific object recognition technology include Scale Invariant Feature Transform (SIFT). Following SIFT, an approach for improving the accuracy was studied, which led to a proposal of the method “PCA-SIFT” or “B SIFT” in which feature amounts are taken into consideration. In addition, in order to deal with the problem of time and calculation cost required for SIFT, a method called “speeded-up robust features (SURF)”, which is a speeded-up SIFT approach, has been proposed, and speedup by GPU has also been proposed. Further, in these object recognition technology, machine learning processing technology typified by deep learning such as convolutional neural networks may be employed as appropriate.

The inference results obtained in Step S506 are sequentially pushed to the result storage queue (Step S507). In an embodiment, this push method is first in first out (FIFO), and is pushed every 10 ms, for example. In this case, 100 inference results will always be stocked in the queue.

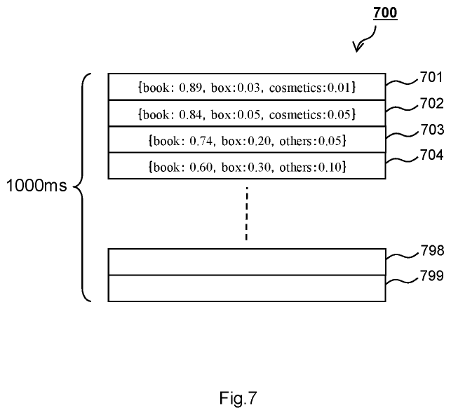

FIG. 7 shows the configuration of a result storage queue in a listing support system or the like according to an embodiment of the present invention. This queue is configured in the memory in any of the devices of information processing server 21 and the user terminals 23a to 23e.

In FIG. 7, for example, the results are pushed to a queue 700 every 10 ms so that the stacks 701 to 799 for 1000 ms (the number of stacks is simply calculated to be 99 but is assumed to be 100 here. Alternatively, there may be stacks 701 to 799 for 990 ms) can be retained. In an embodiment, this queue employs the first in first out (FIFO) method, but the present invention is not limited to this. Various known stacking methods can be adopted.

In an embodiment, one inference result is stored in one stack. For example, a stack 704 stores the inference result of {book: 0.60, box: 0.30, others: 0.10} as the article name (category) shown in the image captured at that moment. This inference result changes every instant and is pushed from the top of the queue 700 one after another (in FIG. 7, the stacks 701 to 703 are already pushed from above, for example). The contents of the stack 704 mean that the name or category of the currently recognized article is a “book” with a probability (estimated probability) of 60%, a “box” with a probability of 30%, and others with a probability of 10%.

FIG. 7 demonstrates that, assuming that the stacks 701 to 704 are the results obtained by a process in which the inference {book: 0.60, box: 0.30, others: 0.10} is pushed to the queue 700 at a moment; the inference {book: 0.74, box: 0.20, others: 0.05} is pushed at the next moment; the inference {book: 0.84, box: 0.05, cosmetics: 0.05} is pushed at the next moment; and the inference {book: 0.89, box: 0.03, cosmetics: 0.01} is pushed at the next moment, the category identifier gradually increases its accuracy (of course, in the scene shown in FIG. 7, what the user terminal is capturing is a “book” not shown in the drawing).

Within a second, the queue 700 is filled with the pushed inference results, and the old stacks are discarded one after another.

In an embodiment, it is assumed that a threshold related to inference in the results stored in the result storage queue is exceeded in Step S508.

At this time, in an embodiment of the present invention, a criterion of “threshold” is adopted to determine the category of the subject inferred by the category identifier. The following criteria can be adopted as this threshold.

(1) Of the stacks in the queue 700, those with the same article or the same category listed ahead of all others account for a predetermined proportion (for example, 90% or more).

(2) Of the stacks in the queue 700, those in which the estimated probability of the same article or the same category listed ahead of all others is a predetermined percentage or more (for example, 60% or more) account for a predetermined proportion (for example, 70% or more).

(3) The stacks including the same article or the same category listed ahead of all others mentioned in (1) and (2) are continuous.

Here, it may be considered that the category of the subject (the article to be listed) has been determined by the category identifier in Step S508. To be specific, examples of the categories include “headphones”, “books”, and “cosmetics”.

In an embodiment of the present invention, after the threshold is exceeded in Step S508, the result for the category is returned to the user terminal (Steps S509a and S509b). This reply can be performed periodically as long as the threshold is exceeded, or can be performed every time the threshold is exceeded. In this case, each time the subject displayed on the user terminal changes, the category of the newly recognized subject is updated and displayed. To be specific, when a “book” is being photographed first, it is recognized as “book” as the article category within a second (the recognized result can be hidden but can be shown as appropriate), and when the camera is pointed at another article (for example, headphones) and held, the newly determined article category “Headphones” is recognized (and displayed if necessary) on the screen within a second.

Alternatively, control can be performed so that no reply is sent in Steps S509a and S509b (for this reason, the arrows corresponding to Steps S509a and S509b are indicated by broken lines).

Next, in Step S510, a shooting command is transmitted from the user terminal to the information processing server through a user operation not shown in the drawing (Step S510). At this time, the user has performed an operation for capturing a listing image of an article whose category has currently been recognized for the first time. At this time, on the assumption that the threshold in the result storage queue is exceeded, the information processing server starts a listing procedure guiding process for the user terminal (Step S511).

Note that online auction systems and online flea market systems require taking pictures (images) of items and the like at the time of listing. In other words, taking a picture (image) of an item is a normal procedure at the time of listing, and the aforementioned function therefore allows the user to receive suggestion of the listing procedure according to the category only by performing the regular listing procedure. In this respect, an excellent UX is achieved.

Step S512 guides to the listing procedure specifically for the target category. In other words, one of the features of the present invention is that the progress or style of the listing procedure differs depending on the recognized category.

Although the description has been made of the communication between the user terminal and the information processing server in an embodiment with reference to FIG. 5, the present invention is not limited to this; in another embodiment of the present invention, the process shown in FIG. 5 is performed in the same user terminal. In this case, the command transmission in Step S502 is command generation in the user terminal, and hereinafter, the image transmission in Steps S505a to S505c is image transfer (for example, between memories) in the user terminal, and the result replies in Steps S509a and S509b are the result outputs in the user terminal. The transmission of the shooting command in Step S510 is command generation in the user terminal.

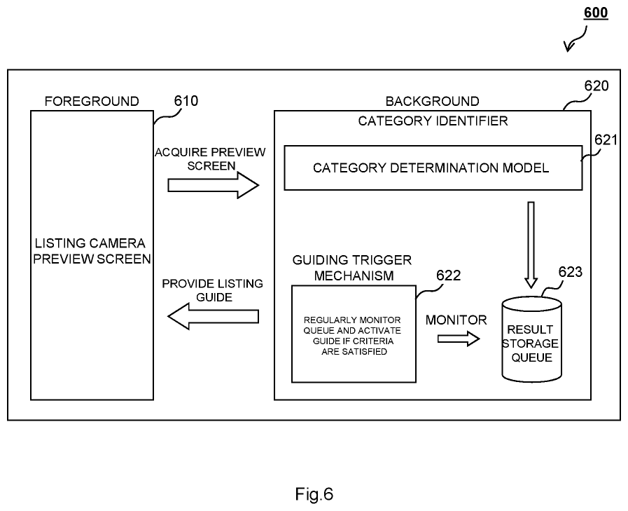

FIG. 6 shows the operation concept of a listing support system according to an embodiment of the present invention. The drawing shows the whole user terminal 600 mainly composed of a foreground processing unit 610 and a background processing unit 620. The main function of the foreground processing unit 610 is the continuous camera photography of a listing item. The captured listing item image is displayed as a “preview image” on the user terminal screen (FIG. 1A (B). The preview image captured in the foreground processing unit 610 is continuously transmitted or transferred to the background processing unit 620.

The main function of the background processing unit 620 is category identification (or object recognition) of the article shown in the transmitted or transferred preview image. Therefore, in an embodiment of the present invention, the category determination model 621 operates. The above-described known category determination technology or the like can be adopted for this model (for example, known general-purpose object recognition technology or specific object recognition technology such as SIFT or SURF). Further, machine learning processing technology such as deep learning may be applied as appropriate.

The determination result given by the category determination model 621 is pushed to the result storage queue 623 at any time. A guiding trigger mechanism 622 monitors the inside of the queue 623, and when the threshold is exceeded, the category of the article is determined and the guidance is triggered (note here that the button operation like in Step S510 in FIG. 5 does not serve as a trigger).

In an embodiment of the present invention, this guidance trigger guides to a listing procedure specifically for the target category.

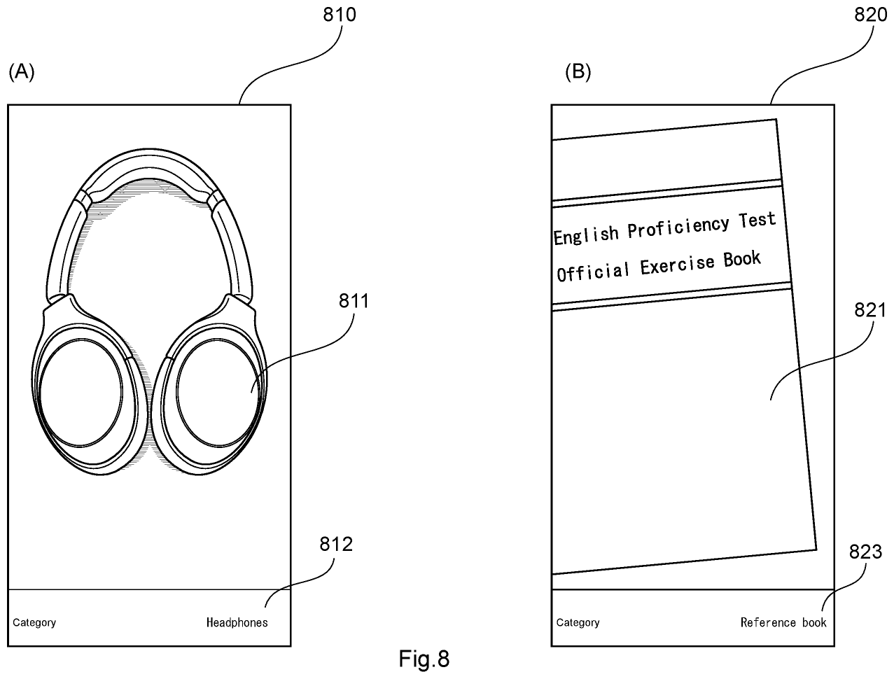

FIG. 8 shows an example screen of an information processing device (user terminal) in the listing support system or the like according to an embodiment of the present invention. Headphones 811 are displayed on the screen 810 in FIG. 8A, and the category identifier recognizes this as “headphones”, so that “headphones” is displayed in the category field 812 on the screen 810. Similarly, a book (exercise book) 821 is displayed on the screen 820 in FIG. 8B, and the category identifier recognizes this as a “book” or a “reference book”, so that “reference book” is displayed in the category field 823 on the screen 820. The displayed image may be a still image or a moving image.

In the case of a moving image, the article name or category name is shown within a second after the subject is displayed, so that it is possible to check the scene of object recognition (or category recognition) in substantially real time (within a second is an exemplary number and the present invention is not limited to this).

In an embodiment, such a scene of object recognition (or category recognition) can be checked in Steps S509a and S509b in FIG. 5.

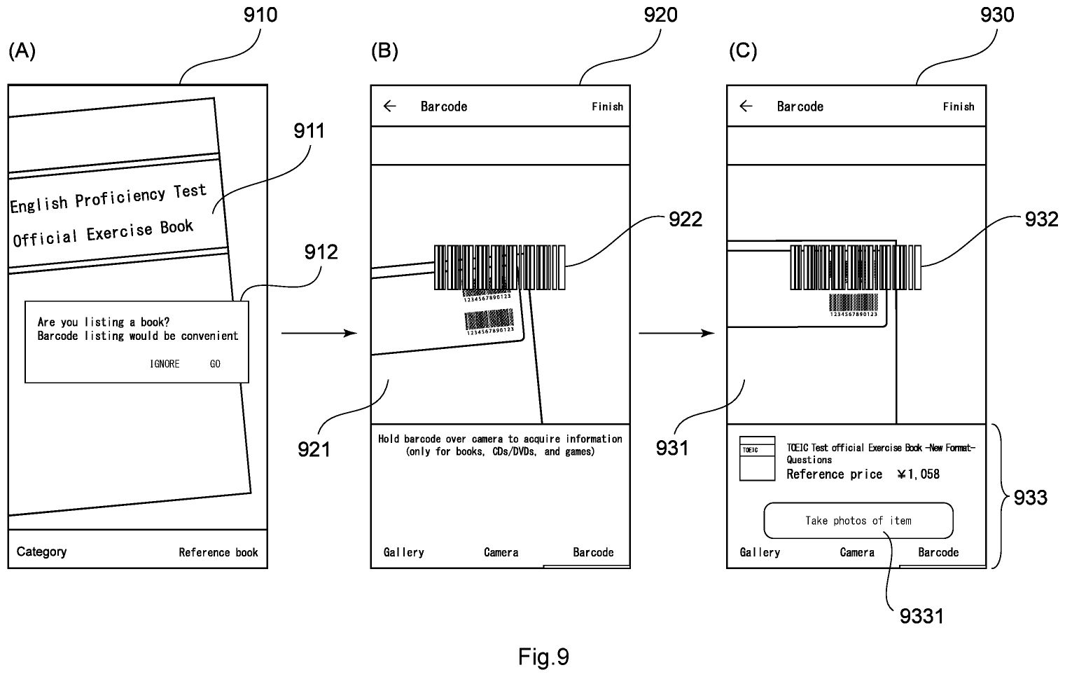

FIGS. 9 to 15 show example screens of the information processing device (user terminal) in the listing support system or the like according to an embodiment of the present invention. FIG. 9 shows an example of guiding to the listing procedure specifically for the target category in Step S512 shown in FIG. 5 in particular. In other words, in FIG. 9, when the recognized category of the article is book (including “exercise book” and “reference book” as subordinate concepts; the same applies to the similar contexts hereinafter), the listing guidance suitable for the category is performed.

The timing of the guidance is after the photography in the example shown in FIG. 5, but the present invention is not limited to this and the guidance may be performed before the photography. FIG. 9 shows an example in which guidance is performed before photography. In this respect, regarding the relationship between Step S510 and Step S511 in FIG. 5, Step S511 may be performed before Step S510.

On the screen 910 of FIG. 9A, the article 911 is already recognized as a reference book (book) by the category identifier, and a message window 912 is shown (for example, with the advice “Are you listing a book? Barcode listing would be convenient”). The message window 912 shows the “GO” button for proceeding to barcode listing according to the advice and the “IGNORE” button for ignoring the advice and proceeding to the listing by a normal procedure not shown in the diagram.

Here, the user presses the “GO” button to proceed to the screen 920 shown in FIG. 9B.

A screen 920 shows a guide 922 for alignment for reading a barcode. The user recognizes from this guide 922 that the barcode should be photographed, and turns the reference book (book) 921 so that the barcode faces the camera, or adjust the camera location (direction to and distance from of the user terminal) so that the barcode printed on the reference book (book) 921 is located near the guide 922. If the barcode is successfully read, the screen 930 of FIG. 9C is displayed.

The screen 930 shows the reference book (book) 931 aligned with the guide 932, and the book information read from the barcode in the reading result field 933. In an embodiment, a barcode contains an identifier such as an ISBN number, and the user terminal reading the barcode transmits the read identifier to the information processing server, and can receive the information on the book (for example, book title, author name, publisher name, and price) from the server, for example.

The reading result field 933 shows the information received in this way.

Next, making sure that the content shown in the reading result field 933 is correct, the user presses the button 9331 shown in this field, and starts photographing the actual item.

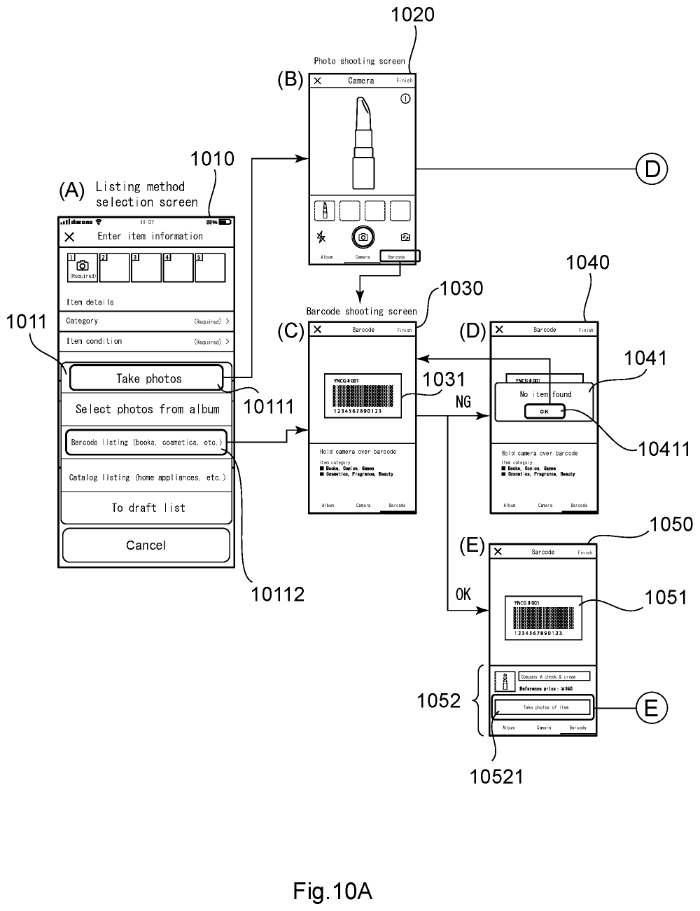

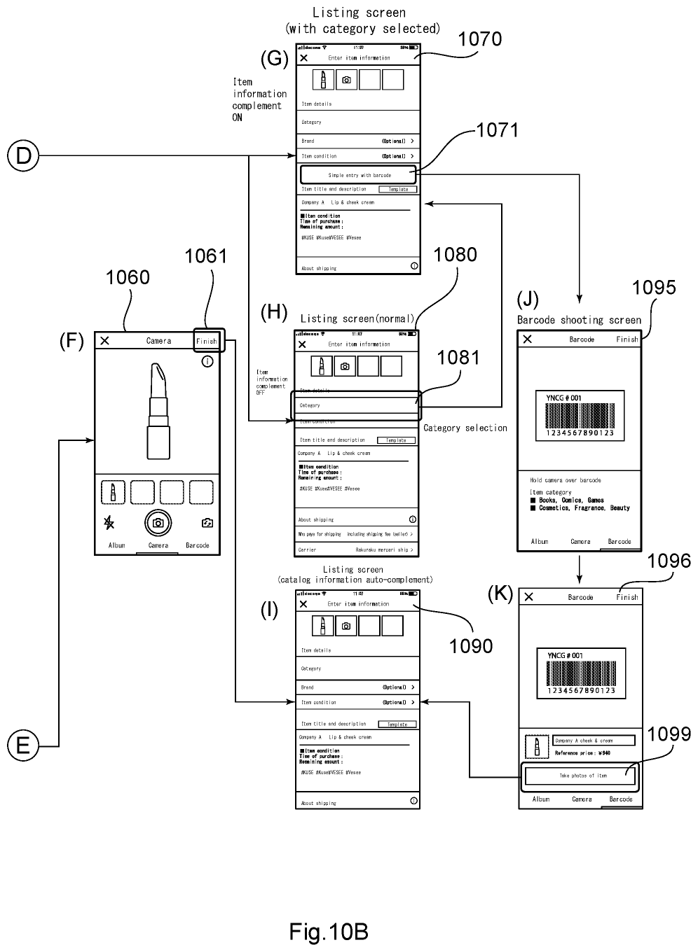

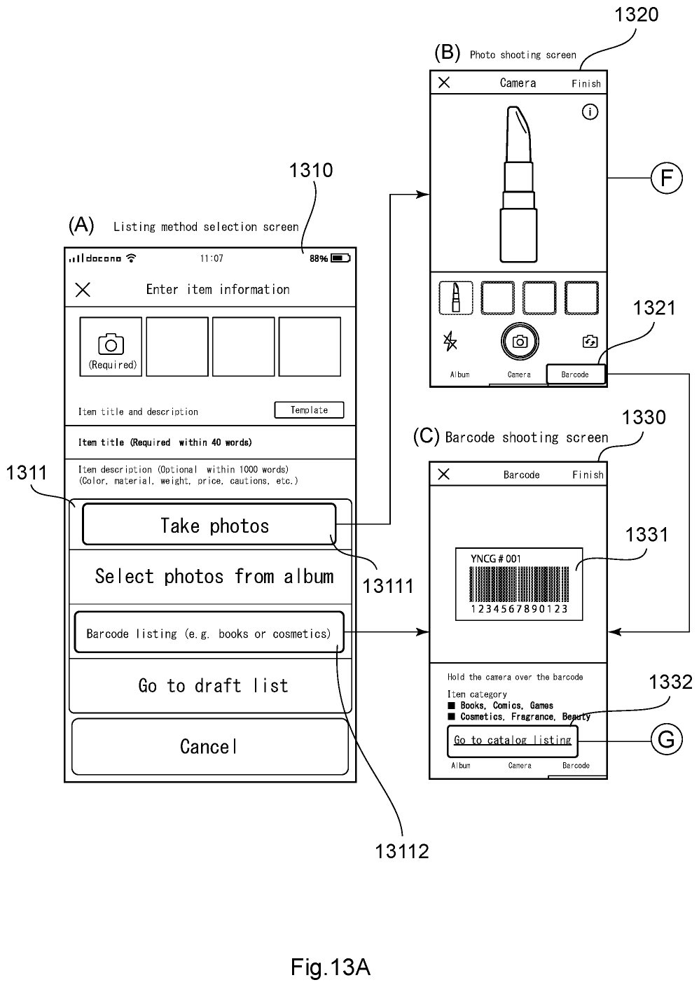

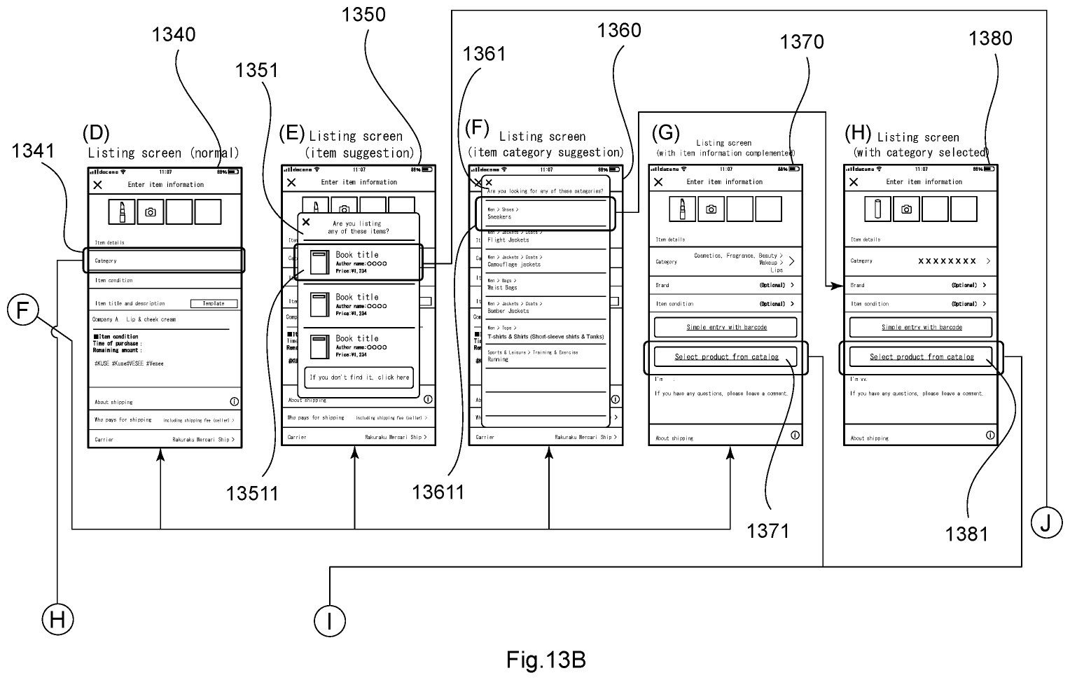

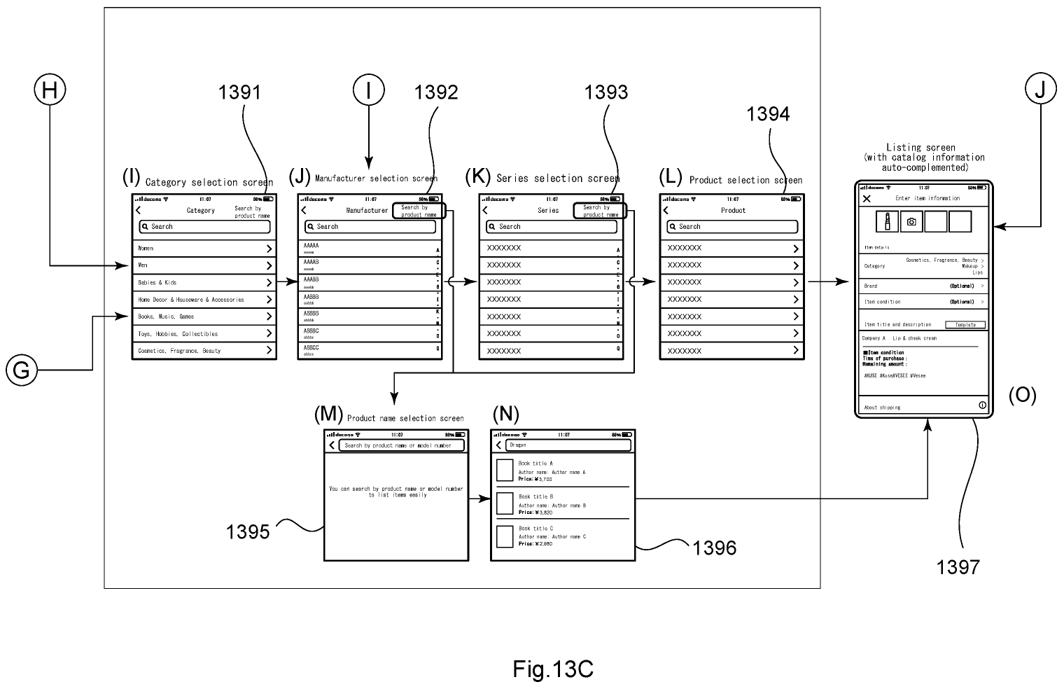

FIGS. 10A and 10B show example screen transitions in the information processing device (user terminal) in the listing support system or the like according to an embodiment of the present invention. Here, many variations which are not always linked to the listing guidance specifically for the target category based on the category recognition result described with reference to FIGS. 1A and 5 and other drawings are shown (other variations will be described with reference to FIG. 13A and the like). These will be described below with reference to FIGS. 10A and 10B.

FIG. 10A (A) shows a listing method selection screen 1011 (which is a different mode of the screen 120) in an embodiment. This screen 1011 is displayed on the top layer of the item information input screen 1010 and selectively consists of, for example, the following contents: a “shooting” button (10111), a “Select picture from album” button, a “Barcode listing” button (10112), and a “Catalog listing” button (each menu also serves as a select menu button that can be pressed or touched). The “See draft list” button is a button for listing the drafts currently being prepared for listing. In addition, a “Cancel” button for canceling the listing method selection screen 1011 and returning to the item information input screen 1010 is also shown at the bottom.

Pressing the button 10111 on the screen 1011 causes a transition to the photo shooting screen 1020 (which is another mode of the screen 130) shown in FIG. 10A (B), and pressing the button 10112 causes a transition to the barcode shooting screen 1030 shown in FIG. 10A (C).

On the screen 1020, the user captures an item image while receiving a guide or the like from an application not shown in the drawing, and when the item information complement setting is ON thereafter, a transition is made to the listing screen (with a category selected) 1070 of FIG. 10B (G) (at this time, the category of the item may be determined by the category determination). After the item image is captured on the screen 1020, if the item information complement setting is OFF, a transition is made to the listing screen (normal) 1080 shown in FIG. 10B (H).

In contrast, pressing the button 10112 on the screen 1011 causes a transition to the barcode shooting screen 1030 shown in FIG. 10A (C). Here, the barcode 1031 printed on the item or item packaging is read. If the reading fails, a transition is made to the screen 1040 shown in FIG. 10A (D), in which a pop-up window 1041 appears and shows the message that no item has been found. Pressing the OK button 10411 on the pop-up window 1041 restores the screen 1030.

When the barcode 1031 is successfully read on the barcode shooting screen 1030, a transition is made to the screen 1050 shown in FIG. 10A (E), and the item information read from the barcode 1051 is shown in the item field 1052. In an embodiment, the user presses the “Capture item image” button 10521 in it to cause a transition to the item shooting screen 1060 shown in FIG. 10B (F).

Proceeding to FIG. 10B (F), upon completion of the item shooting on the item shooting screen 1060 (another mode of the screen 130), the Finish button 1061 is pressed to make a transition to the listing screen (catalog information auto-complement) 1090 shown in FIG. 10B (I). The catalog information auto-complement is a processing function for referring to a catalog database (stored in the information processing server 21 or the like), which is not shown in the drawing, from the information (for example, item model number) serving as a clue of the item, and acquiring the item information on the item to show it on the listing screen (item information screen).

If the category can be automatically identified here, the user can be guided to a screen for selecting catalog information on the subordinate concept. For example, when the category can be identified up to lipstick, it is started with a screen on which the user selects the catalog information on the subordinate concept (in other words, the user does not have to select “cosmetics”).

In contrast, on the listing screen (with a category selected) 1070 in FIG. 10B (G), as an example, a button 1071 for inputting a barcode is pressed and a transition is made to the barcode shooting screen 1095 in FIG. 10B (J). When the barcode reading has succeeded, a transition is made to the screen 1096 shown in FIG. 10B (K), and the item information read from the barcode is shown in the item field at the bottom of the screen. Pressing the button 1099 for taking a picture of the item causes a transition to the listing screen (catalog information auto-complement) 1090 of FIG. 10B (I).

In contrast, on the listing screen (normal) 1080 shown in FIG. 10B (H) on which category entry is necessary, the category field 1081 is pressed, causing a transition to the listing screen (with a category selected) 1070 shown in FIG. 10B (G).

In the listing support system or the like according to an embodiment of the present invention, the aforementioned screen transition control can also be performed.

### (Example Variations of Item Information for Each Category of Listed Articles or Items)

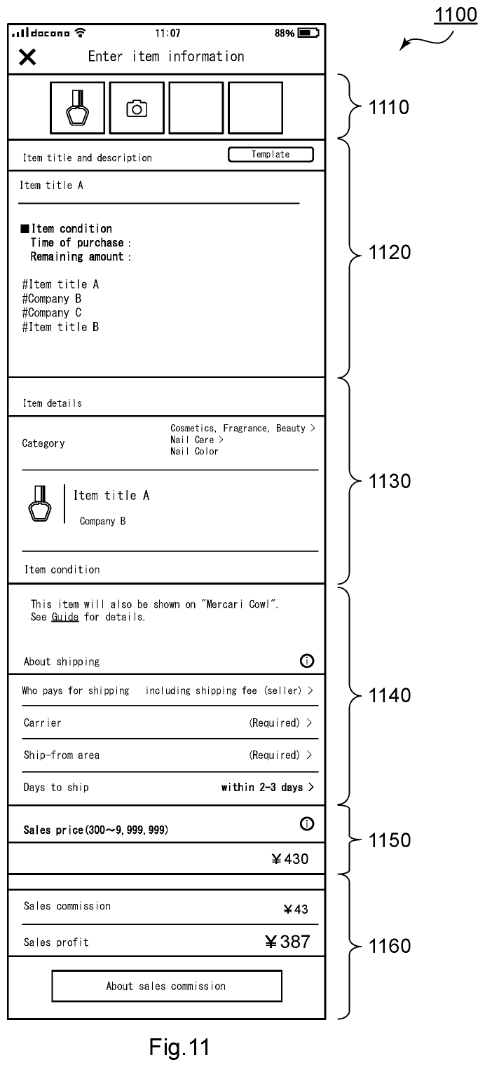

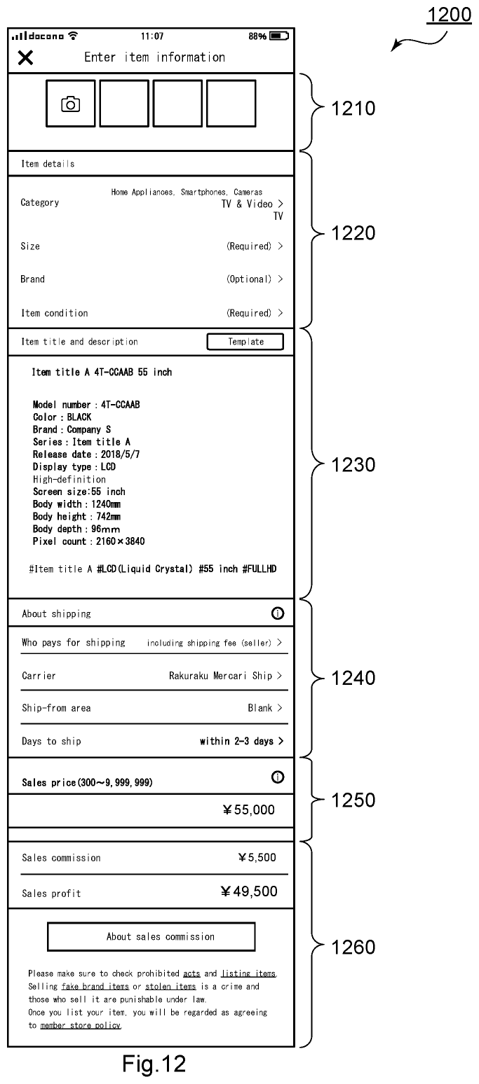

In the listing support system or the like according to an embodiment of the present invention, articles or items belonging to various categories can be listed. However, relevant matter to be input differs depending on the category of each article or item and may vary in a wide range. The variations will be described with reference to FIGS. 11 and 12. The listing support system or the like according to an embodiment of the present invention provides support for facilitating input of item information for each of these categories.

FIG. 11 shows an example screen of an information processing device (user terminal) in the listing support system or the like according to an embodiment of the present invention and indicates item information on an article or item belonging to the cosmetics category. On the screen 1100 shown in FIG. 11, below the item information input selection field 1110, an item information input field 1120 for the item to be listed is located so that information on the introduction time and the remaining amount of the item can be input as information on the status and the like of the item. The character string following the # mark is a hash tag for search. Further, pressing the template button on the upper right of the same field shows a template (not shown in the drawing) for this category (the user may appropriately correct the excess or deficiency of the input information based on the provided template).

In the detailed item information field 1130, item categories down to subordinate concepts are shown and the item name and manufacturing company name of this item already input are shown. An input comment regarding the status of the item or the like can also be shown.

The delivery-related information field 1140 shows information about the delivery charge, delivery method, and the like, and the sales price field 1150 shows the current sales price. The sales commission etc. field 1160 shows, for example, the sales commission and sales profit (which means that the sales price minus the sales commission).

FIG. 12 shows an example screen of an information processing device (user terminal) in the listing support system or the like according to an embodiment of the present invention and indicates item information on an article or item belonging to the home appliances category. In the screen 1200 shown in FIG. 12, the detailed item information field 1220, which is located below the item information input selection field 1210, is configured to show not only information on the categories including the subordinate concepts and the status of the item but the size or brand of the home appliance (for home appliances, it is important to show the size for installation, for example).

An item information input field 1230 is configured to allow various information on an item, such as item name, model number, color, brand, release date, and size, to be input. The character string following the # mark is a hash tag for search. Further, pressing the template button on the upper right of the same field shows a template (not shown in the drawing) for this category (the user may appropriately correct the excess or deficiency of the input information based on the provided template).

The delivery-related information field 1240 shows information about the delivery charge, delivery method, and the like, and the sales price field 1250 shows the current sales price. The sales commission etc. field 1260 shows, for example, the sales commission and sales profit (which means that the sales price minus the sales commission).

### (Variations of Example Screen Transition in User Terminal)

FIGS. 13A to 13C show example screen transitions in the information processing device (user terminal) in the listing support system or the like according to another embodiment of the present invention. These example screen transitions are variations of the screen transition examples described with reference to FIGS. 10A and 10B.

FIG. 13A (A) shows a listing method selection screen 1311 in an embodiment. This screen 1311 is displayed on the top layer of the item information input screen 1310 and selectively consists of, for example, the following contents: a “shooting” button (13111), a “Select picture from album” button, and a “Barcode listing” button (13112) (each menu also serves as a select menu button that can be pressed or touched). The “See draft list” button is a button for listing the drafts currently being prepared for listing. In addition, a “Cancel” button for canceling the listing method selection screen 1311 and returning to the item information input screen 1310 is also shown at the bottom.

Pressing the button 13111 on the screen 1311 causes a transition to the photo shooting screen 1320 shown in FIG. 13A (B), and pressing the button 13112 causes a transition to the barcode shooting screen 1330 shown in FIG. 13A (C).

On the screen 1320, the user captures an item image while receiving a guide or the like from an application not shown in the drawing, and when the item information complement setting, for example, is ON thereafter, a transition is made to any of the following screens: the listing screen 1350 (item suggestion) shown in FIG. 13B (E), the listing screen 1360 (item category suggestion) shown in FIG. 13B (F), and the listing screen 1370 (with item information complemented) shown in FIG. 13B (G), according to the category determined at the time.

After the item image is captured on the screen 1320, if the item information complement setting is OFF, a transition is made to the listing screen (normal) 1340 shown in FIG. 13B (D).

In contrast, pressing the button 13112 on the screen 1311 causes a transition to the barcode shooting screen 1330 shown in FIG. 13A (C). Here, the barcode 1331 printed on the item or item packaging can be read. Further, the screen 1330 shows “Go to catalog listing” button 1332, providing also a guide to item information entry from catalog information.

Here, it is assumed that the “Go to catalog listing” button is pressed, and in that case, a transition is made to the category selection screen 1391 shown in FIG. 13C (I).

Proceeding to FIG. 13B, pressing the category menu 1341 on the listing screen (normal) 1340 shown in FIG. 13B (D) causes a transition to the category selection screen 1391 shown in FIG. 13C (I).

On the listing screen (item suggestion) 1350 shown in FIG. 13B (E), some candidates including captions have already been selected for a listing item category (for example, book or DVD), and the candidate presenting screen 1351 is shown on the top layer. Here, when the user presses the item title 13511 of an item to be listed among the presented candidates, a screen transition is made to the listing screen (catalog information auto-complement) 1397 shown in FIG. 13C (O).

On the listing screen (item category suggestion) 1360 shown in FIG. 13B (F), some candidates have already been selected for a listing item category, and the candidate presenting screen 1361 is shown on the top layer. Here, when the user presses the category 13611 of an item to be listed among the presented candidates, a transition is made to the listing screen (with a category selected) 1380 shown in FIG. 13B (H).

In addition, on the listing screen (with item information complemented) 1370 in FIG. 13B (G), the method “simple entry with barcode” and the method “select product from catalog” are presented as options of entering item information. Here, when the user presses the “select product from catalog” button 1371 among the presented methods, a transition is made to the manufacturer selection screen 1392 shown in FIG. 13C (J).

On the listing screen (with a category selected) 1380 in FIG. 13B (H), the method “simple entry with barcode” and the method “select product from catalog” are presented as options of entering item information. Here, when the user presses the “select product from catalog” button 1381 among the presented methods, a transition is made to the manufacturer selection screen 1392 shown in FIG. 13C (J).

In FIG. 13C, the category selection screen 1391 shown in FIG. 13C (I) to the product selection screen 1394 in FIG. 13C (L) are screen transitions showing scenes in which item information is sequentially narrowed down from categories to products (for example, model numbers). In an embodiment, when an appropriate category is selected from the category list presented on the category selection screen 1391 shown in FIG. 13C (I), a transition is made to the manufacturer selection screen 1392 shown in FIG. 13C (J). Here, selecting an appropriate manufacturer of the item causes a transition to the series selection screen 1393 in FIG. 13C (K), and selecting an appropriate series of the item causes a transition to the product selection screen 1394 in FIG. 13C (L).

Selecting an appropriate product model number or the like on the product selection screen 1394 shown in FIG. 13C (L) causes a transition to the listing screen (catalog information auto-complement) 1397 shown in FIG. 13C (O). Upon transition to this screen, based on the product information determined until then, the catalog information (for example, product specifications) on the product is acquired from the database not shown in the drawing (in an embodiment, this database is stored in the information processing server 21) and automatically inserted on this screen.

In an embodiment of the present invention, a “Search by product name” button is provided on the manufacturer selection screen 1392 shown in FIG. 13C (J) and the series selection screen 1393 shown in FIG. 13C (K). Pressing this button causes a transition to the product name selection screen 1395 shown in FIG. 13C (M). On the screen 1395, the product name and model number can be searched by a known method (not shown in the drawing): for example, the candidates are shown on the candidate selection screen 1396. Selecting an appropriate candidate on the screen 1396 causes a transition to the listing screen (catalog information auto-complement) 1397 shown in FIG. 13C (O). Upon transition to this screen, based on the item information determined until then, the detailed information on the item (for example, information on the item) is acquired from the database not shown in the drawing and automatically inserted on this screen.

### (Variation of the Present Invention Corresponding to Another Category Item Listing)

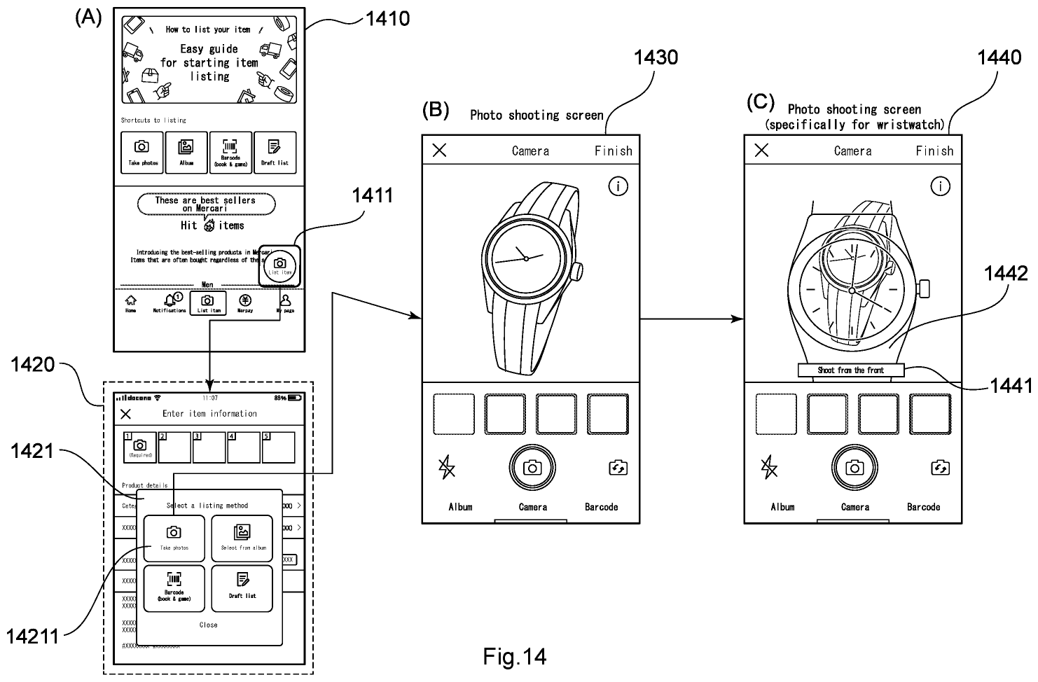

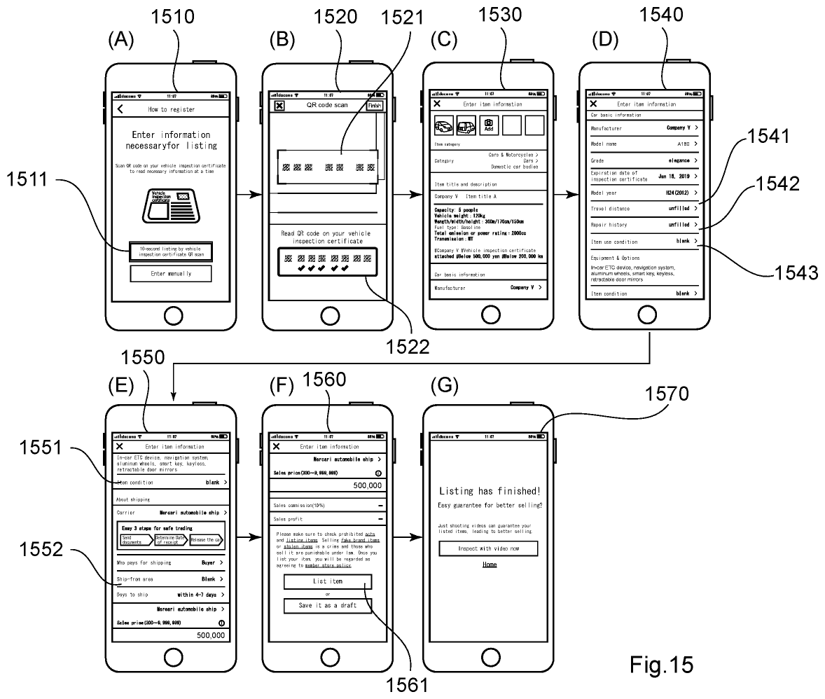

With reference to FIGS. 14 and 15, shown are example screen transitions on the information processing device (user terminal) in the listing support system or the like corresponding to another item or product category that can be handled in an embodiment of the present invention. The example screen transitions shown in FIG. 14 are example guide screens for listing a watch, and the screen transition examples shown in FIG. 15 are example guide screens for listing a car.

Watches and cars have distinctive features as individual items or products, and require entry of unique relevant matters for listing; however, the listing support system and the like according to an embodiment of the present invention can smoothly support listing of these items or products.

FIG. 14A shows a top screen 1410 for starting listing. Pressing the listing button 1411 on the screen 1410 causes a transition to an item information entry screen 1420. In an embodiment, the screen 1420 shows a selection screen 1421 for listing method selection on the top layer. This selection menu screen shows a button 14211 (with the caption “Take photos”) for taking photos and entering listing information, a button (with the caption “Select from album”) for acquiring listing information from an album or catalog and entering it, and a button (with the caption “Barcode (book/game)” for reading the barcode on the item or item packaging to acquire and enter listing information. The “Draft list” button is a button for browsing, for example, pages being prepared for listing and saved as drafts (pressing this button causes a transition to a draft list screen (not shown in the drawing)).

Here, the button 14211 is pressed to cause a transition to the photo shooting screen 1430 shown in FIG. 14B.

The photo shooting screen 1430 shown in FIG. 14B is a screen for shooting a listing image of a listing item (watch). In an embodiment, when object recognition processing on the image shown before the transition to this screen via a normal camera application has started and the category of the listing item is determined to be a watch, a special screen for listing a watch like the screen 1430 appears.

In an embodiment of the present invention, specific object recognition processing for continuously specifying the brand of the watch is continued even after transition to the screen 1430, and the determination results may be shown on the same screen once a specific brand (for example, Rolex or Omega) or a specific model number is determined. A transition is then made from the photo shooting screen 1430 shown in FIG. 13B to the photo shooting screen (specifically for wristwatch) 1440 shown in FIG. 13C.

The photo shooting screen (specifically for wristwatch) 1440 shown in FIG. 14C shows a unique advice message 1441 and a unique guide image 1442 for listing a watch. First, the message 1441 says “Shoot from the front”, and the guide image 1442 is shown. Since the watch (listing item) shown on the screen 1440 through the camera is shot from an oblique angle at a short distance, there is the act that encourages the user to get closer to the listing item so that it overlaps the guide image 1442 and shoot a cut from the front.

Although not shown in FIG. 14, the guide can proceed in the same manner so that, for example, an image of a desired direction and size, such as a side image of the item, can be shot for listing.

FIG. 14 shows an example in which guidance is performed before photography as in FIG. 9.

FIG. 15A shows a start screen 1510 for starting to list a car. In an embodiment of the present invention, before the transition to the screen 1510, a listing support system or the like according to an embodiment of the present invention recognizes the article to be listed as a car, through object recognition (category determination) processing on the image shot by the camera. Hereinafter, the screen transition in FIGS. 15A to 15G is listing guidance made on the assumption that the listing item is a car.

The screen 1510 shown in FIG. 15A shows a menu for selecting whether to advance entry of information on the car to be listed, by scanning the QR code (registered trademark; the same applies hereinafter) printed on the vehicle inspection certificate or by manual entry (the same screen shows a “10-second listing by vehicle inspection certificate QR scan” button 1511 and an “enter manually” button). Here, the button 1511 is pressed, causing a transition to the screen 1520 in FIG. 15B.

The screen 1520 in FIG. 15B shows a camera-shot image located at the upper part of the screen and a guide message and a processing progress indicator 1522 located at the lower part of the screen. In an embodiment, when the user brings the camera closer to the vehicle inspection certificate so that the QR code 1521 printed on the vehicle inspection certificate can be read, the QR codes required by the application are sequentially read (when more than one QR codes should be read, the processing progress can be shown on the processing progress indicator 1522).

Upon completion of reading of the QR code, a transition is made to the screen 1530 shown in FIG. 15C.

The screen 1530 shown in FIG. 15C shows an item information entry screen. Here, relevant matters that can be entered based on the information already read on the screen 1520 have already been automatically entered. Note that in an embodiment, the screen 1530 in FIG. 15C to the screen 1560 in FIG. 15F are a series of screens that can be scroll-browsed, and the item information to be entered and the information already entered automatically on these screens can be checked.

From the screen 1530 to the screen 1560, relevant matters that have not been automatically entered (unfilled fields) are a mileage field 1541, a collection history field 1542, an item usage status field 1543, an item condition field 1551, and a ship-from area filed 1552. It is shown that the comment “unfilled” or the comment “blank” is left in these entry fields.

In an embodiment of the present invention, information can be entered in these unfilled fields by a known method not shown in the drawings. For example, regarding the mileage, the mileage field 1541 is tapped to display a select box (not shown in the drawing) (in an embodiment, the select box not shown in the drawing shows distance ranges like “0 to 1000 km”, “1000 to 3000 km”, “3000 to 10000 km”, “10000 to 30000 km”, “30000 to 50000 km”, “50000 km or more”) so that the user selects and enters an appropriate distance range.

Upon completion of required entry in these unfilled fields, the user scrolls to the screen 1560 shown in FIG. 15F.

The screen 1560 shown in FIG. 15F is configured so that the user can select whether to immediately list this item for which entry of required item information has completed, or save it as a draft (this screen shows a “list item” button 1561 for listing an item and a “save as a draft” button for saving it as a draft).

Here, the button 1561 is pressed, causing a transition to the screen 1570 shown in FIG. 15G.

The screen 1570 shown in FIG. 15G shows a listing complete screen including a message notifying the completion of the listing.

### REFERENCE SIGNS LIST

20 Listing support system
21 Information processing server (group)
22a to 22b User terminal (e.g. PC)
23a to 23e User terminal (e.g. smartphone or tablet)

1.-7. (canceled)

8. A method for providing an article commerce intermediation service on a server configured to be accessible from multiple user terminals, the method comprising:
continuously recognizing an article in an image shot by a user terminal;
extracting a category of the article by the recognition; and
starting a listing procedure for treating the article as a listing item in commerce intermediation based on the extracted category.

9. The method according to claim 8, wherein at least part of the steps is executed on the server.

10. The method according to claim 8, wherein the step of continuously recognizing the article is executed upon the start of the shooting.

11. The method according to claim 8, wherein
the step of continuously recognizing the article includes saving information on the recognition result in a queue,
the listing procedure for treating the article as a listing item in commerce intermediation is started based on the information saved in the queue and the extracted category.

12. The method according to claim 8, wherein the start of the listing procedure is triggered by saving a shot image of the listing item.

13. A system providing an article commerce intermediation service run by a server configured to be accessible from multiple user terminals, wherein
the server and/or the user terminals each
continuously recognize an article in an image shot by the user terminal;
extract a category of the article by the recognition; and
start a listing procedure for treating the article as a listing item in commerce intermediation based on the extracted category.
